(19) United States
(12) Patent Application Publication
(10) Pub. No.: US 2002/0040409 A1
(43) Pub. Date: Apr. 4, 2002

(54) Method and apparatus for implementing state machines as enterprise javabean components

(76) Inventors: Vladimir Matena, Redwood City, CA (US); Mark W. Hapner, San Jose, CA (US); Subodh Bapat, Menlo Park, CA (US)

Correspondence Address: BEYER WEAVER & THOMAS LLP, P.O. BOX 778, BERKELEY, CA, 94704-0778, US

(21) Appl. No.: 09/848,820

(22) Filed: May 3, 2001

Related U.S. Application Data
(60) Provisional application No. 60/217,180, filed on Jul. 10, 2000.

(51) Int. Cl. G06F 9/00; G06F 9/44; G06F 9/46

(52) U.S. Cl. 709/315; 709/104; 709/312

(57) ABSTRACT

Methods and apparatus for implementing state machines as enterprise beans on an enterprise platform are disclosed. According to one aspect of the present invention, a state machine which is arranged to be used within a computing system that supports an enterprise platform includes an entity bean class, a home interface associated with the entity bean class, and a remote interface that is also associated with the entity bean class. The home interface is arranged to create, find, and remove entity objects, while the remote interface being arranged to drive the state machine. In one embodiment, the entity bean class is associated with an entity object. In such an embodiment, the entity object, the home interface, and the remote interface are included in an entity bean which may be an Enterprise JavaBean.

### CROSS REFERENCE TO RELATED APPLICATION

This application takes priority under U.S.C. 119(e) of United States Provisional Application No.: 60/217,180 (Atty. Docket No.: SUN1P294/P5175) filed Jul. 10, 2000 entitled, “METHOD AND APPARATUS FOR IMPLEMENTING STATE MACHINES AS ENTERPRISE JAVABEAN COMPONENTS” by Matena et. al. which is incorporated by reference in its entirety. This application is also related to U.S. patent application Ser. No. ______ (Atty. Docket No.: SUN1P295/P5176) by Matena et. al. filed concurrently herewith and incorporated by reference in its entirety.

### BACKGROUND OF THE INVENTION

1. Field of Invention

The present invention relates generally to computing systems which utilize the Enterprise JavaBeans architecture. More particularly, the present invention relates to implementing state machines in computing systems using Enterprise JavaBeans.

2. Description of the Related Art

The Java 2 Platform, Enterprise Edition (J2EE) is an industry-standard general purpose platform for the development of enterprise business applications. The enterprise business applications developed for J2EE include transaction processing applications, such as purchase order management, or processing transactions on Internet servers. The application logic of these applications is typically implemented as Enterprise JavaBeans (EJB) components. EJB is the application component model of the J2EE platform. One of the key advantages of the EJB component model is that it is relatively easy for application developers to design and implement EJB applications. In addition, as the EJB is a popular industry standard, there are a number of already existing powerful application development tools that further simplify the development of EJB applications.

In general, an EJB component model is a component architecture for the development and the deployment of object-oriented, distributed, enterprise-level applications. An application developed using the EJB component model is scalable and transactional, and is typically portable across multiple platforms, which enables an EJB component to effectively be “written once” and “used substantially anywhere.” That is, EJB components may also be used by multiple applications, i.e., EJB components may be shared or reused. As will be understood by those skilled in the art, the EJB component model enables application development to be simplified due, at least in part, to the fact that typically difficult programming problems are implemented by an EJB container, and not the application.

Some applications utilize state machines, or are designed to use the concept of a state machine in their implementation, and have generally not been developed as EJB components. Specifically, there has been a perceived mismatch between the EJB component model and requirements associated with state machines. A state machine may be considered to be a behavior that specifies the sequences of states that an object goes through during its lifetime in response to events, in addition to its responses to those events. A state of an object is a condition or a situation during the lifetime of an object which satisfies some condition, performs some activity, or waits for one or more events. An event is the specification of an occurrence that has a location in time or space that may trigger a state transition associated with the object.

Applications which use state machines include telecommunications, or “telecom,” applications. Typically, within telecom applications, each telecom vendor uses its own proprietary technique to implement state machines. A state machine which may be used in a telecom application is shown in FIG. 1. FIG. 1 illustrates a state machine that is associated with a base station controller in a wireless telecom network. It should be appreciated that the state machine in the wireless telecom network of FIG. 1 is greatly simplified when to compared to a “real-life” base station controller state machine, for purposes of illustration. A wireless network 100 includes a mobile station (MS) 102, a base transmittal station (BTS) 104, a base station controller 106, and a mobile switching center (MSC) 108. MS 102 may be substantially any device which is suitable for use within cellular network 100, e.g., MS 102 may be a cellular telephone. BTS 104 generally includes radio equipment that controls a cell within cellular network 100. BSC 106 is a telecom application that provides the implementation of call control logic, such as the logic for the setup and the termination of connections. MSC 108 includes telecom equipment that handles the traffic, e.g., voice traffic of established connections, and generally connects the wireless network to the Public Switched Telephone Network (PSTN).

BSC 106 or, more specifically, the telecom application associated with BSC 106, is generally implemented as a connection state machine 114 or a set of connection state machines. Connection state machine 114 implements, among other things, the protocol for the setup of, and the termination of, connections between MS 102 and MSC 108.

The connection setup and termination protocol generally begins when MS 104 requests a connection by sending a RequestConnection event 118 to BTS 104. BTS 104 then sends RequestConnection event 118′ to BSC 106, which causes a connection state machine object to be created within BSC 106 or, more specifically, within the telecom application associated with and running in BSC 106.

Upon creating a connection state machine object, connection state machine 114 sends an AllocateResources event 122 to MSC 108 to essentially request that MSC 108 allocate resources for voice traffic. Once MSC 108 has allocated the requested resources for the call, MSC 108 generates a ResourcesAllocated event 124 which is sent to BSC 106 and indicates that resources have been allocated.

After receiving ResourcesAllocated event 124 from MSC 108, BSC 106 or, more specifically, connection state machine 114 sends a ConnectionEstablished event 128 to BTS 104 indicating that a connection has been established in response to a request from MS 102. In response to receiving ConnectionEstablished event 128, BTS 104 sends ConnectionEstablished event 128′ to MS 102 such that MS 102 is notified of an established connection.

When MS 102 no longer needs a connection, i.e., once MS 104 has completed its use of a connection, MS 102 may “hang up” on the connection. When MS 104 hangs up on the connection, MS 102 sends a TerminateConnection event 132 to BTS 104. Upon receipt of TerminateConnection event 132 by BTS 104, BTS 104 sends TerminateConnection event 132′ to BSC 106 and, hence, connection state machine 114. Connection state machine 114, in turn, sends a DeallocateResources event 136 to MSC 108, which deallocates voice traffic resources, and sends a ResourcesDeallocated event 140 to BSC 106. It should be appreciated that once BSC 106 receives ResourcesDeallocated event 140, BSC 114 deletes the state machine object it allocated in response to RequestConnection event 118′.

FIG. 2 is a state diagram which illustrates an algorithm of a connection state machine, e.g., state machine 114 of FIG. 1. That is, FIG. 2 is an algorithmic representation of an overall connection process associated with cellular network 100 of FIG. 1. A process of implementing a connection begins by receiving a RequestConnection event from a BTS in step 202. The RequestConnection event results in the creation of a connection state machine, and causes transitioning the state machine from the Start state to the Allocating Resources state in step 204. On the entry to the Allocating Resource State in step 204, the state machine sends the AllocateResources event to MSC and starts a timeout. When the MSC allocates the resources, it sends a ResourcesAllocated event in step 206 to the state machine. Such an event causes the state machine to stop the timeout and transition to the ConnectionEstablished state in step 208. Upon entry to the ConnectionEstablished state in step 208, the state machine sends the ConnectionEstablished event to the BTS.

When resources are allocated, the connection is considered to be established, and voice traffic is allowed to “flow” over the cellular telecommunications network. Once the connection is no longer needed, the BTS sends a TerminateConnection event in step 210. The event causes the state machine to transition to the DeallocatingResources state in step 212. On the entry to the Deallocating Resources state, the state machine starts a timeout and sends the DeallocateResources event to the MSC.

After the MSC deallocates the resources, its sends the ResourcesDeallocated event in step 214. When the state machine receives the event, it stops the timeout and transitions to the final state, concluding the process of implementing a connection. In the course of allocating resources, timeouts may occur, as will be appreciated by those skilled in the art. When timeouts occur during the allocation of resources or the deallocation of resources, cleanups occur, as for example in steps 216 and 218. Once cleanups have occurred, the process of implementing a connection is terminated.

The use of proprietary techniques by different telecom vendors to implement state machines makes it difficult for them to use a standard off-the-shelf platform to implement the state machines. Further, the costs associated with developing and maintaining state machines implemented using proprietary techniques may be relatively high.

Therefore, what is needed is a standard method for enabling state machines to be efficiently implemented in telecom applications such that their implementations may be run on an industry standard platform. That is, what is desired is a method and apparatus for implementing state machines as EJB components within a J2EE platform.

### SUMMARY OF THE INVENTION

The present invention relates to implementing state machines as enterprise beans on an enterprise platform. According to one aspect of the present invention, a state machine which is arranged to be used within a computing system that supports an enterprise platform includes an entity bean class, a home interface associated with the entity bean class, and a remote interface that is also associated with the entity bean class. The entity bean class, the home interface, and the remote interface collectively implement entity objects. In the present invention, a state machine corresponds to an entity object. The home interface may be used to create, find, and remove state machines, while the remote interface may be used to drive the state machine transitions. In one embodiment, the entity objects, the entity bean class, the home interface, and the remote interface are realized as an Enterprise JavaBean entity bean component.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a diagrammatic representation of the interactions of an example of a state machine for establishing connections associated with a telecommunications application.

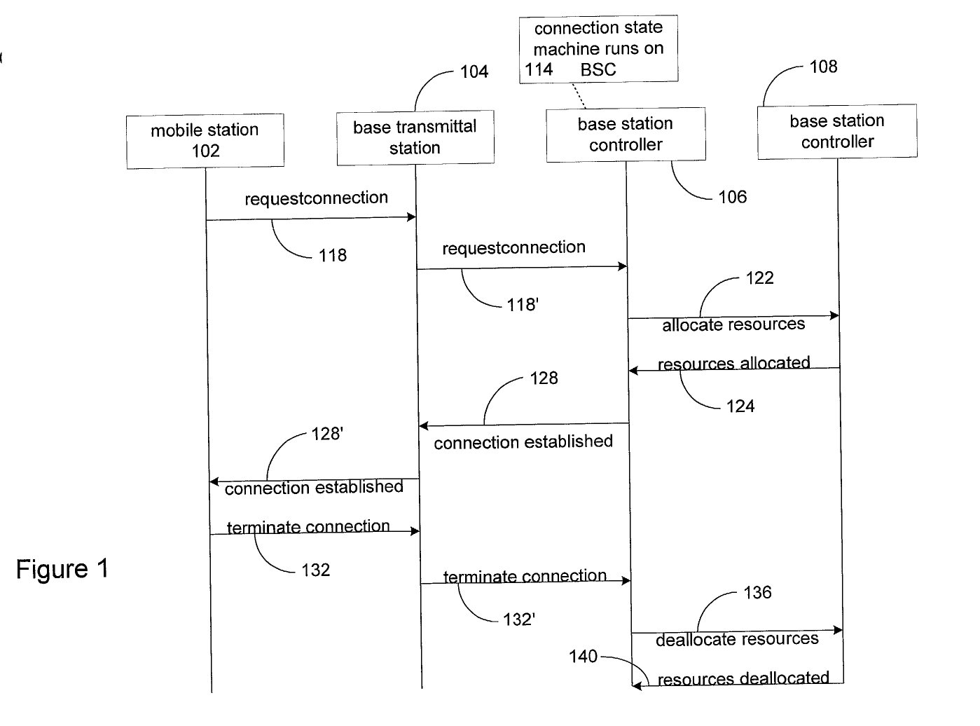

FIG. 2 is a state diagram which illustrates the algorithm of an example of a connection state machine, e.g., state machine 114 of FIG. 1.

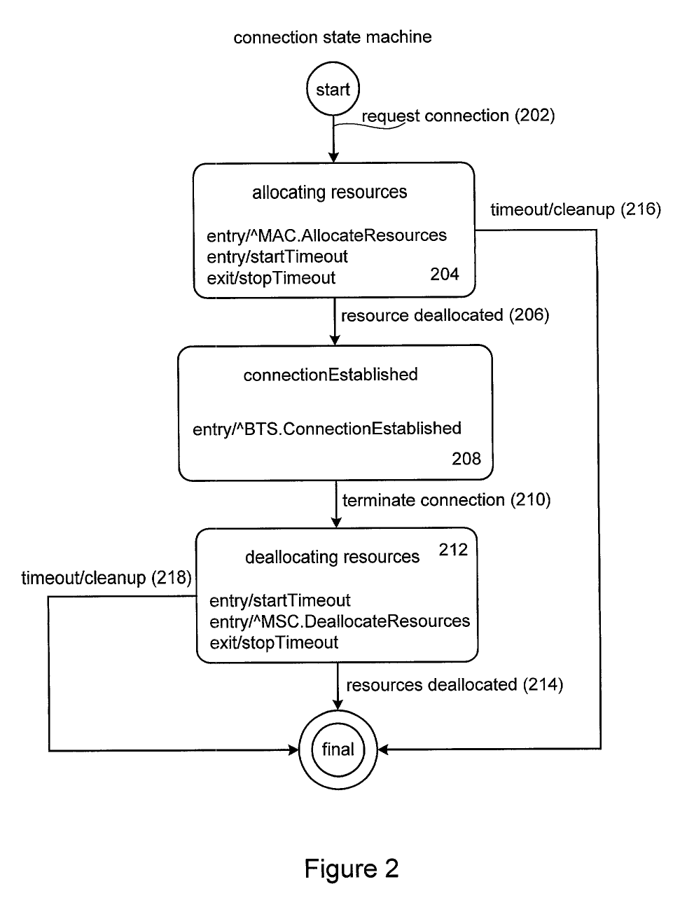

FIG. 3 is a diagrammatic representation of a JavaBean component to which a state machine may be mapped in accordance with an embodiment of the present invention.

FIG. 4 is a diagrammatic representation of an entity bean, e.g., entity bean 302 of FIG. 3, deployed in an Enterprise JavaBean container in accordance with an embodiment of the present invention.

FIG. 5 is a diagrammatic representation of an Enterprise JavaBean container, e.g., container 408 of FIG. 4, which includes a timer object in accordance with an embodiment of the present invention.

FIG. 6 is a diagrammatic representation of actions performed by a state machine implemented as an Enterprise JavaBean component in accordance with an embodiment of the present invention.

FIG. 7 is a diagrammatic representation of a state machine implemented as a plurality of Enterprise JavaBean components in accordance with another embodiment of the present invention.

FIG. 8 is a diagrammatic representation of an Enterprise JavaBean component deployed in an Enterprise JavaBean container which receives input events over different communication protocols in accordance with another embodiment of the present invention.

FIG. 9 is a diagrammatic representation of a typical, general-purpose computer system suitable for implementing the present invention.

### DETAILED DESCRIPTION OF THE EMBODIMENTS

Enabling vendors of applications that implement state machines, such as those vendors associated with the telecommunications, or “telecom,” industry, to implement state machines on an industry-standard Java 2 Enterprise Edition (J2EE) platform as Enterprise JavaBean (EJB) components reduces the costs associated with the applications that implement state machines. The ability to implement state machines as enterprise bean components, in general, allows the state machines to be portable, as well as reused in multiple applications. State machines that are mapped to enterprise bean components may also enable overall applications to be more readily developed, as difficult problems may be implemented by containers associated with the enterprise bean components, and not by the enterprise bean components.

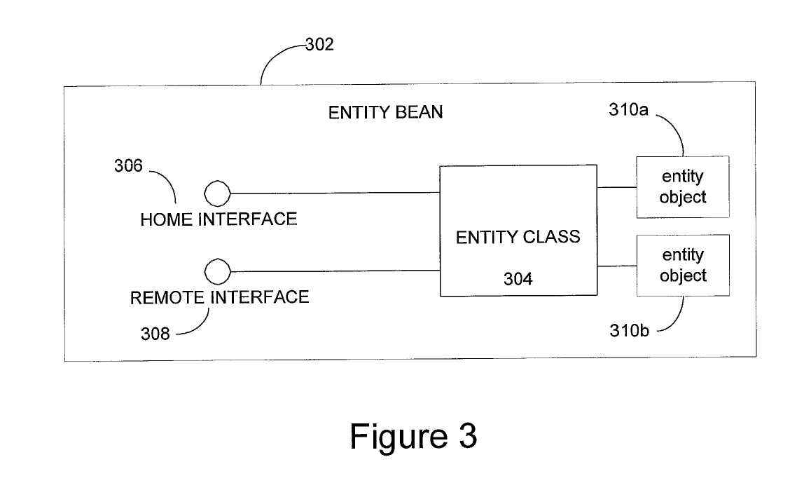

With reference to FIG. 3, an enterprise bean component that is suitable for the implementation of a state machine will be described in accordance with an embodiment of the present invention. An enterprise bean 302, which may be an Enterprise JavaBean, is generally a component which is either a session bean or an entity bean. In the described embodiment, in order to be implemented as a state machine, enterprise bean 302 is an entity bean.

Entity bean 302 includes an entity bean class 304. The methods of entity bean class 304 generally implement the state transitions of state machines. An individual state machine may be represented by an entity object 310. Entity bean 302 includes a home interface 306 and a remote interface 308. Home interface 306 is arranged to create, to find, and to remove individual state machines 310. Remote interface 308 defines a collection of methods which correspond to the events that drive the state machine transitions. The events are received from outside of enterprise bean 302. In other words, remote interface 308 defines a method for each input event that a state machine, i.e., entity object 310, needs to respond to. Further, remote interface 308 may be used by clients to effectively “drive” a state machine, i.e., to cause state transitions on entity objects 310.

Enterprise, or entity, bean 302 is typically deployed in a container. A container, as will be appreciated by those skilled in the art, is generally an entity that provides life cycle management, security, concurrency, deployment, and runtime services to the components deployed within the container. In the described embodiment, the container in which enterprise bean 302 is deployed within is an EJB container, which is a container that implements the EJB component contract per the EJB architecture. The EJB component contract is arranged to specify a runtime environment for enterprise bean 302 that includes, but is not limited to, security, life cycle management, transaction, concurrency, and deployment.

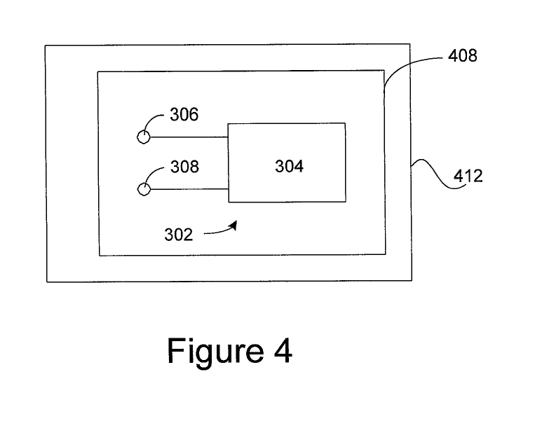

FIG. 4 is a diagrammatic representation of an enterprise bean 302 deployed in a container in accordance with an embodiment of the present invention. A container 408 in which enterprise bean 302 is deployed may be a part of a J2EE platform 412. In general, container 408 responds to events received through J2EE platform 412 by invoking enterprise bean 302 via the corresponding methods of remote interface 308 of enterprise bean 302.

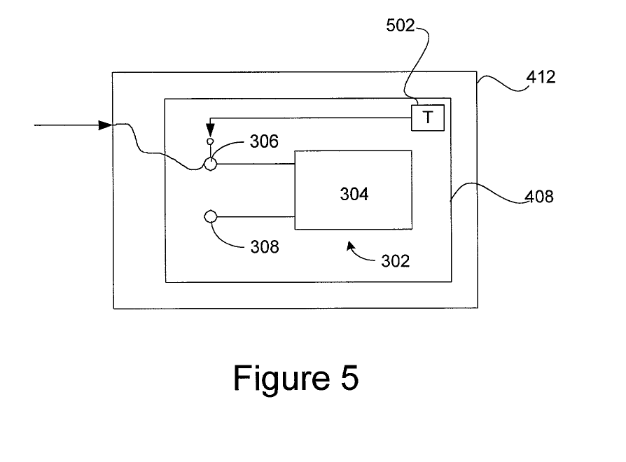

In one embodiment, when a state machine, i.e., entity object 310 of FIG. 3, needs to respond to the passing of time or timeouts, remote interface 308 extends a TimedObject interface. The TimedObject interface, or a similar interface, is arranged to allow container 408 to substantially deliver a timeout event to entity object 310. As shown in FIG. 5, container 408 may include a timer T 502. Container 408 is effectively responsible for the implementation of timeouts through the use of timer T 502. Timer T 502 is arranged to notify the object that implements the TimedObject interface 504. Specifically, when a timeout period associated with timer T 502 expires, container 408 invokes the timeout method on entity object 310 through the TimedObject interface 504. An implementation of timer T 502 is described in co-pending U.S. Provisional Patent Application No. ______ (Atty. Docket No.: SUN1P295P/P5176), filed on even date, which is incorporated herein by reference.

For a state machine that is implemented as an entity bean, states are persistent such that if the state machine suffers a failure, the states are recoverable. Individual states of a state machine may be implemented using a combination of Java classes and primitive Java types. It should be appreciated that the instances of the Java classes or the primitive Java types may be stored in one or more container-managed persistence (CMP) fields of the enterprise bean class that represents the state machine.

In the described embodiment, the actions performed by a state machine during state transitions may be implemented as method invocation to Java objects. An action, typically, is an executable atomic computation which may occur in response to an event. A state transition is effectively a relationship between two states indicating that an object in a source state may perform certain actions and enter a target state when a specified event occurs and specified conditions are satisfied.

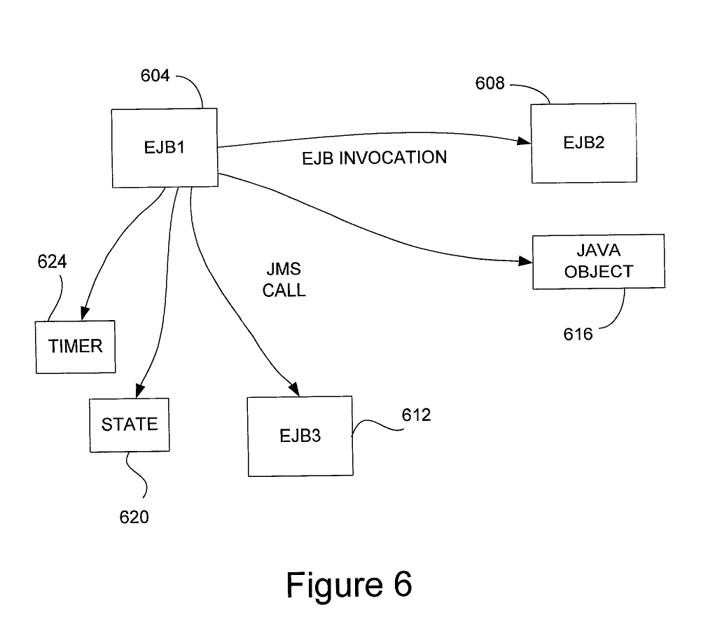

FIG. 6 is a diagrammatic representation of the types of actions performed by a state machine implemented as an enterprise bean in accordance with an embodiment of the present invention. An action is typically performed when a method in a Java class associated with a state machine is invoked through a remote interface of the state machine. A first enterprise bean object 604 which represents a state machine may perform an action by making an object invocation, e.g., an EJB object invocation, to a second enterprise bean object 608. First enterprise bean object 604 may also perform an action on, e.g., make an asynchronous call to, an enterprise bean object 612 which represents a state machine by using a message service such as a Java message service (JMS). Other actions which may be performed by first enterprise bean object 604 include, but are not limited to, making calls to a timer 624 within its container to start and stop timeouts, creating, modifying, and destroying objects 616 such as Java objects, and updating a state 620 by creating, modifying, and destroying CMP objects that represent state 620.

As will be appreciated by those skilled in the art, a state machine generally has a start state and a final state. A start state represents an initial state, and a final state represents an end state. In the described embodiment, both a start state and a final state may be implemented by the non-existence of an entity object representing the state machine. By way of example, if an enterprise bean or state machine represents a call such as a telephone call, then the start state is when there is no connection to make the call and the final state is when the connection is terminated after the call. Hence, both the start state and the end state are characterized by no connection and, hence, no state.

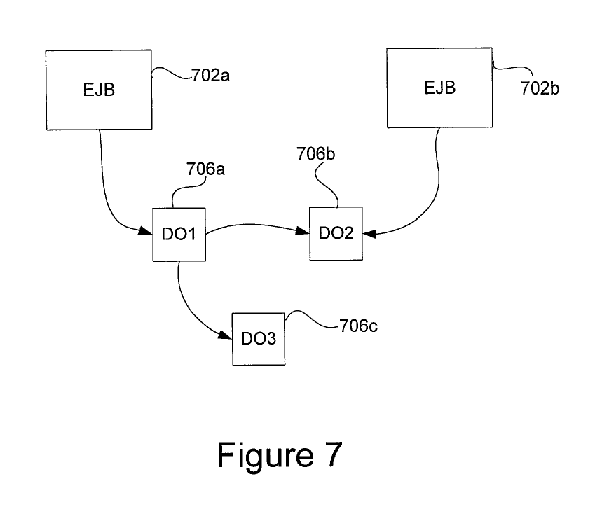

While a state machine has been described as including an enterprise bean that is a single entity bean, a state machine may generally include more that one enterprise bean. That is, a state machine may be mapped to more than a single enterprise bean or entity bean. FIG. 7 is a diagrammatic representation of a state machine which includes more than one enterprise bean in accordance with an embodiment of the present invention. Enterprise beans 702 are part of a state machine and may be invoked remotely. Specifically, input events coming from different sources may be delivered to a state machine using different enterprise beans 702 or bean objects. For example, events from one source may be delivered using enterprise bean 702a while events from another source may be delivered using enterprise bean 702b.

As shown, enterprise beans 702 may invoke on dependent objects 706 using the EJB CMP applications programming interface (API). Dependent objects 706, in generally, may not be invoked remotely, and each represent a part of the entity object state. For a state machine that includes more than one enterprise bean 702, the state of the state machine is effectively the union of the CMP fields of all enterprise beans 702 associated with the state machine, plus the transitive closure of all dependent objects reachable from the CMP fields.

A CMP implementation of a state may cover substantially any suitable API that is associated with enterprise beans, e.g., Enterprise JavaBeans. Within the Enterprise JavaBeans 1.1 Specification, by Vlada Matena and Mark Hapner (Sun Microsystems, Inc., 1999), which is incorporated herein by reference, one suitable CMP API types is defined. Within the Enterprise JavaBeans 2.0 Specification, by Linda DeMichiel at al. (Sun Microsystems, Inc., 2000), which is incorporated herein by reference, a second form of CMP API types is defined. The types differ in the manner (API) in which the entity bean methods access the state. One CMP API type may be called an EJB 1.1 CMP type, and may access entity object state by accessing fields in a Java class. A second CMP type may be called an EJB 2.0 CMP type, and may use accessor methods to access entity object state. By way of example, an API which supports accessing entity object state by accessing fields in a Java class may obtain the address of a company using a command such as “company.address,” while an API which supports accessing entity object state by using accessor methods may obtain the address of the company using a command such as “getCompany( ).getAddress( )” and change the address by using a command such as “getCompany( ).setAddress(newAddress)”, as will be understood by those skilled in the art.

In general, an enterprise bean container may use an enterprise bean transaction to substantially enforce the atomicity of actions performed during state transitions. Enforcing the atomicity of actions enables the state of the state machine to remain consistent in the presence of failures. For instance, if the updating of a state uses four actions, three of which are successful, but the fourth fails, the container cancels the three successful actions to maintain consistency.

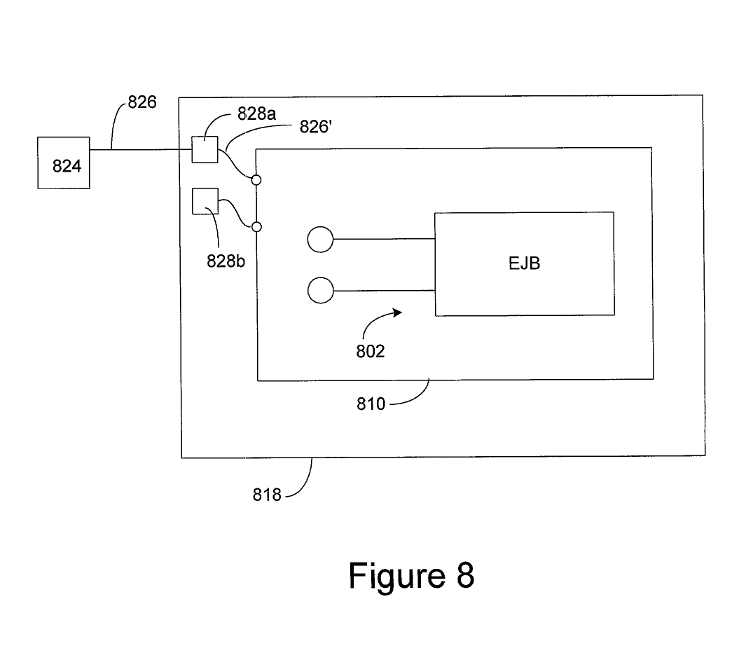

As described above, when a specified event occurs and specified conditions are satisfied, a state machine may perform one or more actions and enter a second state from a first state. Specified events may be associated with receiving messages over a variety of different protocols. FIG. 8 is a diagrammatic representation of an enterprise bean component or object deployed in an EJB container which receives input events over different protocols in accordance with another embodiment of the present invention. Enterprise bean component 802 is deployed within EJB container 810, which is part of the J2EE platform 818. When a client 824 sends an input event 826, software 828 which supports various protocols processes event 826 and delivers processed event 826′ to container 810. In one embodiment, client 824 may be a network element provided by a telecommunication vendor. The term “network element” is a term well known to those skilled in the telecommunication industry.

Software 828 is generally associated with protocols used to receive messages or events 826. Their embodiments are usually called protocol drivers. In general, events 826 may be of substantially any type. Events types include, but are not limited to, JMS, remote method invocation Internet inter-ORB protocol (RMI-IIOP), RMI/JRMP, substantially any form of a remote procedure call (RPC), and substantially any internet protocol (IP).

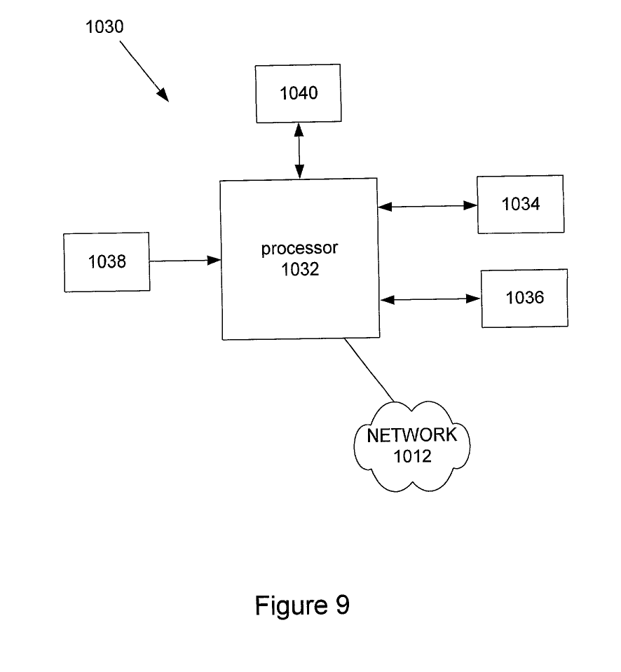

FIG. 9 illustrates a typical, general-purpose computer system suitable for implementing the present invention. The computer system 1030 includes at least one processor 1032 (also referred to as a central processing unit, or CPU) that is coupled to memory devices including primary storage devices 1036 (typically a read only memory, or ROM) and primary storage devices 1034 (typically a random access memory, or RAM).

As is well known in the art, ROM acts to transfer data and instructions uni-directionally to the CPUs 1032, while RAM is used typically to transfer data and instructions in a bi-directional manner. CPUs 1032 may generally include any number of processors. Both primary storage devices 1034, 1036 may include any suitable computer-readable media. A secondary storage medium 1038, which is typically a mass memory device, is also coupled bi-directionally to CPUs 1032 and provides additional data storage capacity. The mass memory device 1038 is a computer-readable medium that may be used to store programs including computer code, data, and the like. Typically, mass memory device 1038 is a storage medium such as a hard disk or a tape which generally slower than primary storage devices 1034, 1036. Mass memory storage device 1038 may take the form of a magnetic or paper tape reader or some other well-known device. It will be appreciated that the information retained within the mass memory device 1038, may, in appropriate cases, be incorporated in standard fashion as part of RAM 1036 as virtual memory. A specific primary storage device 1034 such as a CD-ROM may also pass data uni-directionally to the CPUs 1032.

CPUs 1032 are also coupled to one or more input/output devices 1040 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 1032 may be coupled to a computer or telecommunications network, e.g., an internet network or an intranet network, using a network connection as shown generally at 1012. With such a network connection, it is contemplated that the CPUs 1032 might receive information from the network, or might output information to the network in the course of performing the above-described method steps. Such information, which is often represented as a sequence of instructions to be executed using CPUs 1032, may be received from and outputted to the network, for example, in the form of a computer data signal embodied in a carrier wave. The above-described devices and materials will be familiar to those of skill in the computer hardware and software arts.

Although only a few embodiments of the present invention have been described, it should be understood that the present invention may be embodied in many other specific forms without departing from the spirit or the scope of the present invention. By way of example, a state machine which is implemented using of more than one enterprise bean which is an entity bean object has been described as including two enterprise beans. It should be appreciated, however, that any number of enterprise beans and dependent objects may be used in the implementation of a state machine.

The implementation of state machines as enterprise beans, or the mapping of state machines into enterprise beans, has been described as being suitable for use in a telecom application. In general, however, the implementation of state machines as enterprise beans may be applied to substantially any type of application which utilizes state machines. That is, telecom applications are only one example of applications to which enterprise beans may be applied in accordance with the present invention.

While the use of enterprise beans to implement a state machine has been generally been described in terms of Enterprise JavaBeans and the J2EE platform, substantially any suitable enterprise bean and platform may be used in the implementation of state machines. That is, the present invention is not intended to be limited to a Java computing environment and, instead, may be applied to substantially any suitable computing environment.

It should be appreciated that entity beans may utilize either bean-managed persistence (BMP) or CMP without departing from the spirit or the scope of the present invention. BMP and CMP may be considered to be alternative ways to implement state in an entity bean. In addition, other types of persistence may also be used to implement state in an entity bean, i.e., the present invention is not to be limited to the use of only either BMP or CMP. Therefore, the present examples are to be considered as illustrative and not restrictive, and the invention is not to be limited to the details given herein, but may be modified within the scope of the appended claims.

What is claimed is:

1. A state machine, the state machine being arranged to be used within a computing system that supports an enterprise platform, the state machine implementation comprising:
an entity bean class;
a home interface associated with the entity bean class, the home interface being arranged to create, find, and remove entity objects;
a remote interface associated with the entity bean class, the remote interface being arranged to drive the state machine in response to the input events; and
an entity object associated with the entity bean class, the entity object being arranged to represent an individual state machine.

2. A state machine according to claim 1 wherein the entity bean class, the entity object, the home interface, and the remote interface are parts of an entity bean.

3. A state machine according to claim 2 wherein the entity bean is an enterprise bean

4. A state machine according to claim 3 wherein the enterprise bean is an Enterprise JavaBean.

5. A state machine according to claim 2 wherein the entity bean is arranged to be deployed in a bean container that that is arranged to invoke instances of the entity bean class in response to invocations to the methods of the remote interface.

6. A state machine according to claim 5 wherein the bean container is further arranged to implement a timeout.

7. A state machine according to claim 5 wherein the entity bean uses container-managed persistence to maintain a state associated with the state machine.

8. A state machine according to claim 5 wherein the entity bean uses bean-managed persistence to main a state associated with the state machine.

9. A state machine according to claim 5 wherein the bean container is arranged to receive input events to the entity bean and to dispatch the received input events to the methods of the remote interface

10. A state machine according to claim 1 wherein the remote interface is arranged to define a method for an input event to which the state machine responds.

11. A state machine method used within a computing system that supports an enterprise platform comprising:
providing an entity bean class;
providing a remote interface associated with the entity bean class, the remote interface being arranged to drive the state machine in response to the input events;
providing an entity object associated with the entity bean class, the entity object being arranged to represent an individual state machine; and
providing a home interface associated with the entity bean class, the home interface being arranged to create, find, and remove entity objects.

12. A state machine method according to claim 11 wherein the entity bean class, the entity object, the home interface, and the remote interface are parts of an entity bean.

13. A state machine method according to claim 12 wherein the entity bean is an enterprise bean

14. A state machine method according to claim 13 wherein the enterprise bean is an Enterprise JavaBean.

15. A state machine method according to claim 12 wherein the entity bean is arranged to be deployed in a bean container that that is arranged to invoke instances of the entity bean class in response to invocations to the methods of the remote interface.

16. A state machine method according to claim 15 wherein the bean container is further arranged to implement a timeout.

17. A state machine method according to claim 15 wherein the entity bean uses container-managed persistence to maintain a state associated with the state machine.

18. A state machine method according to claim 15 wherein the entity bean uses bean-managed persistence to main a state associated with the state machine.

19. A state machine method according to claim 15 wherein the bean container is arranged to receive input events to the entity bean and to dispatch the received input events to the methods of the remote interface

20. A state machine method according to claim 11 wherein the remote interface is arranged to define a method for an input event to which the state machine responds.
